(19) United States
(12) Patent Application Publication
(10) Pub. No.: US 2011/0117446 A1
(43) Pub. Date: May 19, 2011

(54) INHIBITION OF ELECTROLYTE OXIDATION IN LITHIUM ION BATTERIES WITH ELECTROLYTE ADDITIVES

(75) Inventors: Brett Lucht, Wakefield, RI (US); Li Yang, Kingston, RI (US); Mengqing Xu, Kingston, RI (US); Ang Xiao, Tucson, AZ (US)

(73) Assignee: The Board of Governors for Higher Education, State of Rhode Island and Providence Plantations, Providence, RI (US)

(21) Appl. No.: 12/975,477

(22) Filed: Dec. 22, 2010

Related U.S. Application Data
(63) Continuation of application No. PCT/US2009/049534, filed on Jul. 2, 2009.
(60) Provisional application No. 61/077,927, filed on Jul. 3, 2008.

(51) Int. Cl. H01M 10/056

(52) U.S. Cl. 429/332; 429/331

(57) ABSTRACT

A lithium ion battery electrolyte for use in lithium ion batteries. The electrolyte includes LiPF₆, LiBF₄, LiB(C₂O₄)₂, or a related salt dissolved in a mixture of organic carbonate, ether or ester solvents with low concentrations of oxidatively unstable additives such that the additives react with a surface of cathode particles to generate a passivation film which prevents oxidation of the electrolyte by the cathode. The additive is a polymerizable organic molecule selected from 2,3-dihydrofuran (2,3-DHF), 2,5-dihydrofuran (2,5-DHF), vinylene carbonate (VC), vinyltrimethoxysilane (VTMS), dimethyl vinylene cabonate (DMVC), and gamma-buyrolactone, or related unsaturated ethers, esters, or carbonates.

### PRIORITY INFORMATION

The present application claims the benefit of U.S. Provisional patent application Ser. No. 61/077,927 which was filed on Jul. 3, 2008, all of which is incorporated herein in its entirety.

### BACKGROUND OF THE INVENTION

For many years, nickel-cadmium had been the only suitable battery for portable equipment from wireless communications to mobile computing. Nickel-metal-hydride and lithium-ion emerged in the early 1990s, fighting nose-to-nose to gain customer's acceptance. Today, lithium-ion is the fastest growing and most promising battery chemistry.

The most common type of lithium ion batteries in consumer products contains a graphitic carbon anode, a lithiated cobalt oxide (LiCoO2) cathode, and an electrolyte composed of lithium hexafluorophosphate (LiPF6) in a mixture of carbonate solvents which includes ethylene carbonate (EC).

The most limiting operation problem with the lithium-ion battery over a wide range of temperatures is the electrolyte itself. For example, lithium-ion battery performances decline at as the operating temperature goes below −10° C. and also deteriorate at temperatures above 60° C.

Common lithium-ion battery electrolytes are derived from LiPF₆ salt in a solvent blend of ethylene carbonate (EC) and various linear cobonates such as dimethyl carbonate (DMC), diethyl carbonate (DEC) and ethylmethyl carbonate (EMC). EC and LiPF₆ are found in most commercially available electrolyte formulations. The two electrolytes determine the temperature limits of the lithium-ion battery.

Lithium ion batteries are one of the most widely used portable power sources. However, loss of power and capacity and upon storage or prolonged use especially at elevated temperature (>50° C.) limits the application of LIB for electric vehicle (EV) and hybrid electric vehicle (HEV) applications. The performance degradation is frequently linked to the thermal instability of LiPF₆ and the reactions of the electrolyte with the surface of the electrode materials. This has prompted the development of alternative electrolytes for lithium ion batteries.

The most widely utilized lithium salt for lithium ion batteries is lithium hexafluorophosphate (LiPF₆). However, LiPF₆ has poor thermal and hydrolytic stability and is thus not ideal. One of the most widely investigated “alternative” salts for lithium ion battery electrolytes is lithium bisoxalatoborate (LiB(C₂O₄)₂, LiBOB). Lithium ion batteries containing LiBOB based electrolytes have been reported to operate up to 70 ° C. with little capacity fade. However, the use of LiBOB has been limited by the poor solubility of LiBOB in common carbonate solvents and the poor performance of LiBOB electrolytes at low temperature. LiBOB based electrolytes have been reported to generate a stable solid electrolyte interface (SEI) on the surface of the anode due to ring-open reactions of the oxalate moiety and the formation of trigonal borates.

### SUMMARY OF THE INVENTION

The development of the next generation of lithium ion batteries for EV, HEY or PHEV required the development of improved electrolytes. The improvements in electrolytes came from the development of novel salts, novel solvents, or novel additives that improve the properties of currently available salt/solvent combinations.

The invention is directed to a lithium ion battery electrolyte for use in lithium ion batteries. The electrolyte comprises LiPF₆, LiBF₄, LiB(C₂O₄)₂, or a related salt dissolved in a mixture of organic carbonate, ether or ester solvents with low concentrations of oxidatively unstable additives such that the additives react with a surface of cathode particles to generate a passivation film which prevents oxidation of the electrolyte by the cathode.

Two types of cathode film forming additives have been developed. The first type of additive includes organic molecules which can undergo cationic polymerization. This class of additives includes 2,3-dihydrofuran (2,3-DHF), 2,5-dihydrofuran (2,5-DHF), vinylene carbonate (VC), vinyltrimethoxysilane (VTMS), and gamma-buyrolactone. The second class of additive includes organic soluble inorganic reagents which can react with the surface of the cathode to modify the surface structure.

These and other objects, features and advantages of the present invention will become apparent in light of the following detailed description of preferred embodiments thereof, as illustrated in the accompanying drawings.

### BRIEF DESCRIPTION OF THE DRAWINGS

FIG. 1 is a graph to illustrate the anodic stability of the electrolyte with and without additives;

FIG. 2 is a graph to show the cycling performance of the electrolyte with and without electrolyte;

FIG. 3 is a graph to illustrate the EIS impedance of the cathodes;

FIG. 4 is a chart of XPS spectra of the cycled cathodes; and

FIG. 5 is FTIR-ATR spectra of the cycled cathodes.

### DETAILED DESCRIPTION OF THE INVENTION

Two types of cathode film forming additives have been developed including an organic molecules which can undergo cationic polymerization, this class of additives includes 2,3-dihydrofuran (2,3-DHF), 2,5-dihydrofuran (2,5-DHF), vinylene carbonate (VC), vinyltrimethoxysilane (VTMS), dimethyl vinylene carbonate (DMVC), and gamma-buyrolactone or related unsaturated ethers, esters, or carbonates. A second class of additives includes organic soluble inorganic reagents which can react with the surface of the cathode to modify the surface structure.

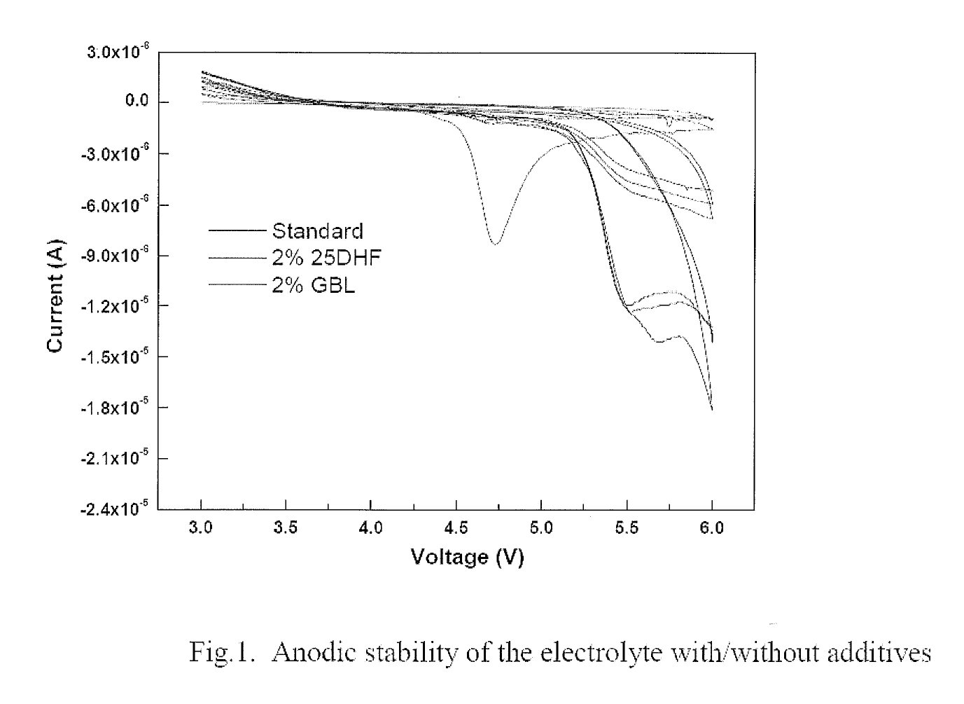

The reduction potential of the anode in lithium ion batteries is high enough to reduce common electrolytes (salt and solvent) in lithium ion batteries. However, during the first few charge cycles, a solid electrolyte interface (SEI) is generated on the surface of the anode which protects the electrolyte from further reduction. Anode film forming additives have been widely investigated in lithium-ion battery electrolytes. The additives are reduced on the surface of the anode to form more stable anode SEIs. The investigation of cathode film forming additives has received much less attention. While studying VC (an anode film forming additive) in lithium ion batteries, it was noted that VC also reacts on the surface of the cathode. The oxidation of VC by the cathode results in the formation of organic polymer films composed of polyether, polycarbonates, and poly(VC) on the surface of the cathode particles as evidenced by IR spectroscopy (See FIG. 1).

LiPF₆/carbonate electrolytes are oxidatively stable above 4.5 V in the presence of non-active electrodes. However, the active cathode materials (LiCoO₂, LiMn₂O₄, LiNi_{0.33}Co_{0.33}Mn_{0.33}O₂, LiFePO₄, and related materials) catalyze the oxidation of the electrolyte at lower potentials. Therefore, additives have been developed which are preferentially oxidized to form a cathode SEI and inhibit the oxidative reactions of the cathode with the electrolyte in a similar fashion to the inhibition of the reduction of the electrolyte by the anode SEI. The cathode SEI acts as a passivating layer preventing further oxidation of the electrolyte and allowing the cathodes to be cycled to higher voltages.

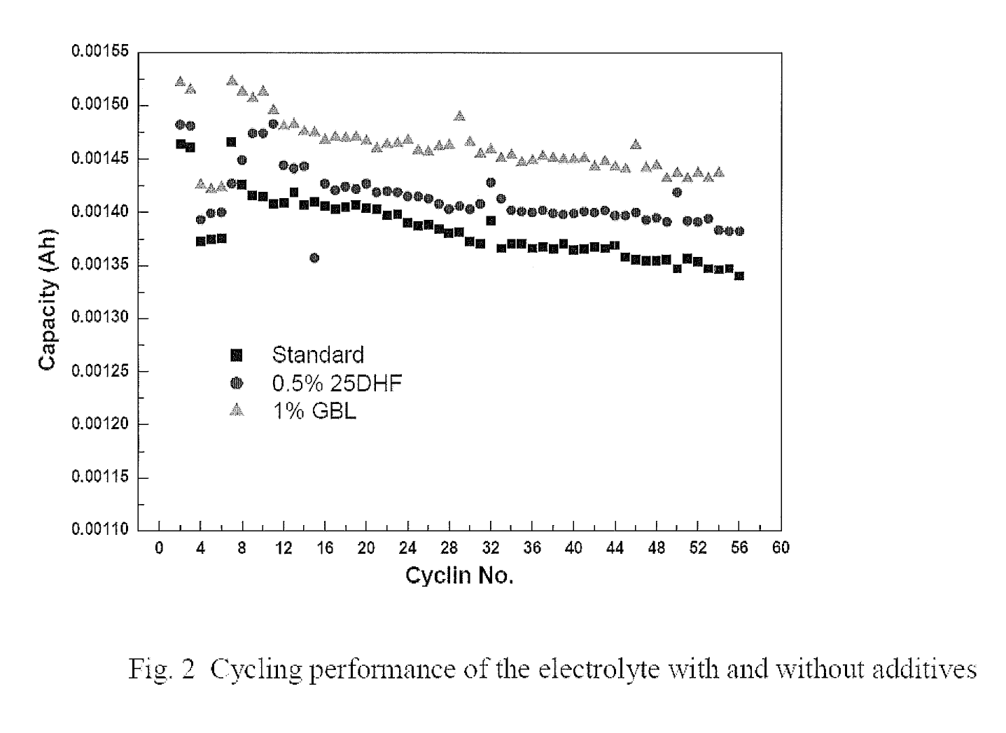

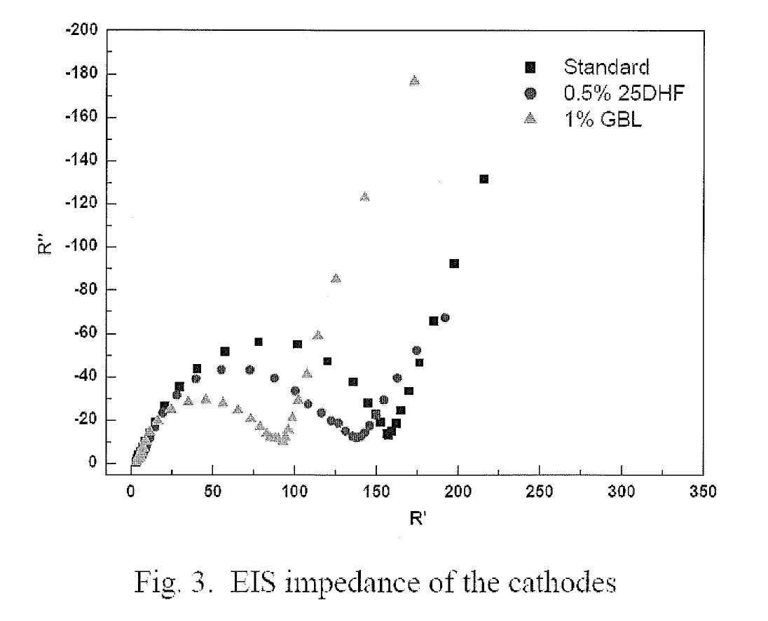

Cyclic voltammetry of LiPF6/carbonate electrolytes with and without film forming additives indicate that after the first cycle, electrolytes containing the additives can be cycled to higher voltages before oxidation reactions occur (See FIG. 2). The onset of oxidation for samples containing 2,3-dihydrofuran is almost 1 V higher than the standard electrolyte. Preliminary investigations were conducted on lithium-ion coin cells cycled between 3.0 and 4.5 V (vs Li). The cells were cycled once at C/20 followed by C/10 charge-discharge rate cycles at 20° C. The addition of VC, 2,3-DHF, or 2,5-DHF to ternary electrolyte results in the formation of a cathode solid electrolyte interphase (SEI) and significantly increases the capacity retention of cells cycled to 4.5 V (See FIG. 3, Table 1). The addition of 0.1% 2,5-DHF results in a 50% reduction in the capacity fade after 20 cycles. This confirms that additives can form a passivating layer on the cathode and improve the cycle life at higher voltages.

Anodic stability of the electrolyte with/without additives

From FIG. 1, it can see that the standard electrolyte has an anodic stability around 5.2 V versus lithium metal on a glassy carbon electrode, while the addition of 2% 2,5-DHF rendered a lower voltage threshold at 4.75 V, for the first scan. However, the electrolyte containing 2% 2,5-DHF has a higher anodic stability during the following scans (up to 6.0 V) without significant faradic current. The 2,5-DHF can decompose under electrochemical driving force to form an effective crosslinked, PEO-like surface film on the electrode in the first scan. This strongly suggests that the addition of 2,5-DHF passivates the surface of the glassy carbon electrode and prevents further oxidation of the electrolyte. The addition of 2% GBL renders a smaller decomposition current, compared with that of the standard electrolyte, due to the formation of a similar protecting surface film.

Study of layered Li_{1.17}Mn_{0.58}Ni_{0.25}O₂, PVDF as binder
Cycling performance

As can be seen from FIG. 2, the addition of 0.5% 25DHF and 1% GBL rendered a better cycling performance than the standardelectrolyte. The cells containing the additives have higher capacity when cycled to 5.0 V than the cells without additives.

### Electrochemical Impedance Spectroscopy (EIS)

The EIS impedance of the cycled half cells is listed in FIG. 3. The standard cell has larger impedance than cells containing either 0.5% 2,5-DHF or 1% GBL. This is consistent with the additives inhibiting electrolyte oxidation on the surface of the cathode.

X-ray photoelectron spectroscopy (XPS) of cycled cathodes

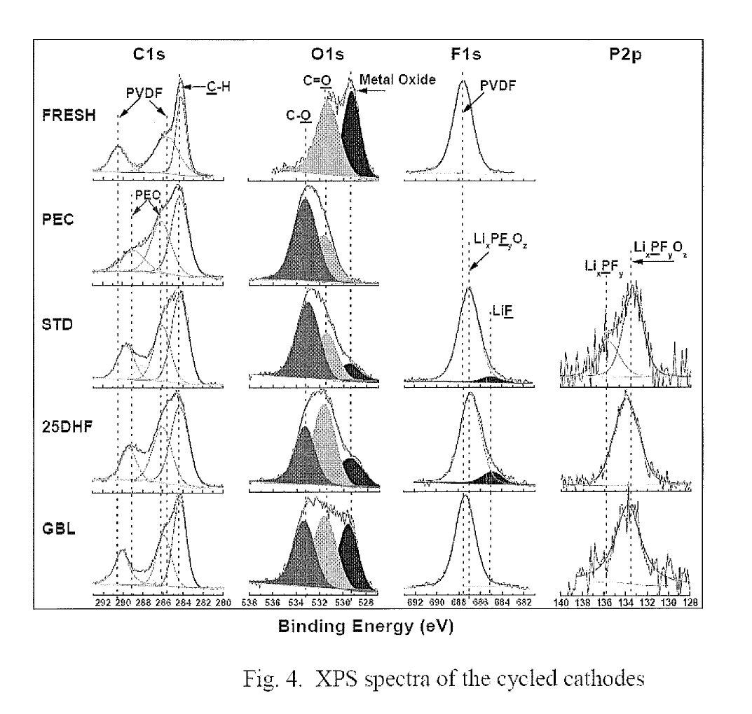

FIG. 4 lists the XPS spectra of the Fresh, PEC and cycled cathodes.

From the C1s spectra, one can observe that the fresh cathode is composed of PVDF (C-F at 290.3 eV and C-H at 285.7 eV), conductive carbon, and lithium carbonate (Li₂CO₃). Upon cycling a cell in the presence of the standard electrolyte, significant concentrations of polyethylene carbonate (PEC) at 289 eV for C=O and 286 for C-O build up. This surface PEC forms as a result of oxidation of the electrolyte.

Significant differences were also observed in O1 s spectra. The fresh cathode is mainly composed of metal oxide (529.5 eV) and Li₂CO₃ (531.5 eV). The PEC is composed of the C-O (533.5 eV) and C=O (531.8 eV). The cathode extracted from the cell cycled with the standard electrolyte contains a surface film which is mainly composed of PEC, the intensity of C-O is higher than that of C=O. The cells with added 2,5-DHF or GBL have a much greater intensity of metal oxide (529.5 eV) and C=O from Li₂CO₃ suggesting a thinner surface film. In addition, the cells have lower relative concentration of PEC.

From the F1s spectra, a strong signal for PVDF at 687.7 eV is observed. There are only small changes to the structure of the F containing species with or without incorporation of additives.

FTIR-ATR of cycled cathodes

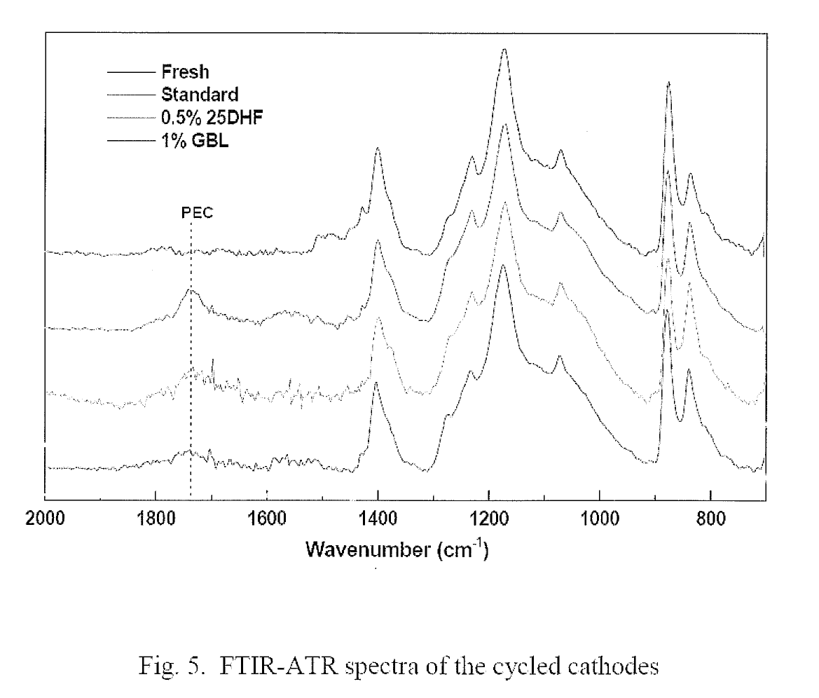

FTIR-ATR spectra of the fresh and cycled cathodes are listed in FIG. 5. PVDF is the dominating signal for all cathodes. For the standard cathode, we can see strongest PEC signal at 1740 cm⁻¹, although the 1250 cm⁻¹ is overshadowed by the PVDF. The concentration of PEC is reduced upon addition of either 2,5-DHF or GBL. This is consistent with the additives inhibiting the oxidation of the electrolyte and suggests that incorporation of these additives will allow the cells to be cycled to higher voltages, such as 5.0 V vs Li.

Generally, a typical lithium battery includes an anode made of graphite or other related form of carbon silicon, silicon/graphite composites, lithium metal, and lithium alloys. The active cathode material may be selected from the group consisting of LiCoO₂, LiMn₂O₄, LiFePO₄, LiNiₓCo₁₋ₓO₂, LiNi_{1/3}Mn_{1/3}O₂, and related materials.

The additive may be an inorganic molecule selected from the group consisting of titanium tetramethoxide, titanium tetraethoxide, titanium tetraisopropoxide, aluminum trimethoxide, aluminum triethoxide, aluminum triisopropoxide, trimethylborate, triethylborate, triisopropyl borate, tetramethyl orthosilicate, tetraethyl orthosilicate, tetraisopropyl orthosilicate, and related titanium tetralakoxide, trialkyl borates, aluminium trialkoxides, and tetraalkyl orthosilicates. The additive selectively reacts with a surface of the cathode particles to generate a novel cathode electrolyte interface. The additives are typically in the range of 0.01-10% by weight and preferably 0.05-5.00% by weight.

The lithium-ion battery usually has a separator which is typically porous polyethylene or porous polypropylene. The separator provides physical separation of the two electrodes allowing ionic conduction while preventing electrical conduction. The remaining portions of the battery are those standard in the industry.

Although the present invention has been shown and described with respect to several preferred embodiments thereof, various changes, omissions and additions to the form and detail thereof, may be made therein, without departing from the spirit and scope of the invention.

What is claimed is:

1. A lithium ion battery electrolyte for use in lithium ion batteries, said electrolyte comprising LiPF₆, LiBF₄, LiB(C₂O₄)₂, or a related salt dissolved in a mixture of organic carbonate, ether or ester solvents with low concentrations of oxidatively unstable additives such that said additives react with a surface of cathode particles to generate a passivation film which prevents oxidation of the electrolyte by the cathode.

2. The lithium ion battery electrolyte of claim 1, wherein said additive is a polymerizable organic molecule selected from 2,3-dihydrofuran (2,3-DHF), 2,5-dihydrofuran (2,5-DHF), vinylene carbonate (VC), vinyltrimethoxysilane (VTMS), dimethyl vinylene cabonate (DMVC), and gamma-buyrolactone, or related unsaturated ethers, esters, or carbonates.

3. The lithium ion battery electrolyte of claim 2, wherein the additive concentration is 0.01-10% by weight.

4. The lithium ion battery electrolyte of claim 3, wherein the additive concentration is 0.05%-5% by weight.

5. The lithium ion battery electrolyte of claim 1 where said additive is an inorganic molecule selected from the group consisting of titanium tetramethoxide, titanium tetraethoxide, titanium tetraisopropoxide, aluminum trimethoxide, aluminum triethoxide, aluminum triisopropoxide, trimethylborate, triethylborate, triisopropyl borate, tetramethyl orthosilicate, tetraethyl orthosilicate, tetraisopropyl orthosilicate, and related titanium tetralakoxide, trialkyl borates, aluminium trialkoxides, and tetraalkyl orthosilicates.

6. The lithium ion battery electrolyte of claim 5, wherein the additive concentration is 0.01-10% by weight.

7. The lithium ion battery electrolyte of claim 6, wherein the additive concentration is 0.05%-5% by weight.

8. A lithium ion battery electrolyte of claim 1, wherein the additive selectively reacts with a surface of the cathode particles to generate a novel cathode electrolyte interface.

9. A lithium ion battery electrolyte of claims 1 wherein the active cathode material is selected from the group consisting of LiCoO₂, LiMn₂O₄, LiFePO₄, LiNiₓCo₁₋ₓO₂, LiNi_{1/3}CO_{1/3}Mn_{1/3}O₂, and related materials.

10. A lithium ion battery electrolyte of claim 1, wherein the anode material is graphite and other related forms of carbon, silicon, silicon/graphite composites, lithium metal, and lithium alloys.

11. A lithium ion battery, said battery comprising
an anode;
a cathode;
an electrolyte comprising LiPF₆, LiBF₄, LiB(C₂O₄)₂, or a related salt dissolved in a mixture of organic carbonate, ether or ester solvents with low concentrations of oxidatively unstable additives such that said additives react with a surface of cathode particles to generate a passivation film which prevents oxidation of the electrolyte by the cathode, and wherein said additive is a polymerizable organic molecule selected from 2,3-dihydrofuran (2,3-DHF), 2,5-dihydrofuran (2,5-DHF), vinylene carbonate (VC), vinyltrimethoxysilane (VTMS), and gamma-buyrolactone.

12. A method of cycling a lithium-ion battery to produce a protective film on a cathode, said method comprises:
providing a outer container to maintain the battery;
providing a cathode having a surface of particles;
providing an anode;
providing a separator;
an electrolyte comprising LiPF₆, LiBF₄, LiB(C₂O₄)₂, or a related salt dissolved in a mixture of organic carbonate, ether or ester solvents with low concentrations of oxidatively unstable additives such that upon cycling the battery, said additives react with the surface of cathode particles to generate a passivation film on said cathode surface which prevents oxidation of the electrolyte by the cathode.

13. The method of claim 12, wherein said additive is a polymerizable organic molecule selected from 2,3-dihydrofuran (2,3-DHF), 2,5-dihydrofuran (2,5-DHF), vinylene carbonate (VC), vinyltrimethoxysilane (VTMS), dimethyl vinylene carbonate (DMVC), and gamma-buyrolactone, or related unsaturated ethers, esters, or carbonates.

14. The method of claim 12, wherein the separator is porously polyethylene or polypropylene.
